(19) United States
(12) Patent Application Publication
(10) Pub. No.: US 2006/0117331 A1
(43) Pub. Date: Jun. 1, 2006

(54) Compact disk player for vehicles

(75) Inventors: Min Gon Joo, Kyunggi-do (KR); Jae Woo Jun, Kyunggi-Do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 11/109,927

(22) Filed: Apr. 19, 2005

(30) Foreign Application Priority Data
Dec. 1, 2004 (KR) 2004-99942

(51) Int. Cl. G11B 3/70; G11B 5/84; G11B 7/26; G11B 17/04

(52) U.S. Cl. 720/626

(57) ABSTRACT

The present invention provides a compact disk player for vehicles which includes a disk identification device that mechanically identifies the size of a disk inserted into the compact disk player regardless of the size of the disk and allows the disk to be loaded into the interior of the compact disk player.

### BACKGROUND OF THE INVENTION

1. Field of the Invention

The present invention relates generally to compact disk players for vehicles and, more particularly, to a compact disk player for vehicles in which, when one of different-sized disks is inserted into the compact disk player, the size of the disk is mechanically identified and, thereafter, the disk is loaded into the interior of the compact disk player.

2. Description of the Related Art

Generally, compact disk players for vehicles are devices for reproducing the information recorded on the disks using optical systems.

The general construction of the compact disk players is as follows. The compact disk players include a turntable to seat a disk thereon, and a disk loading unit to load the disk into the interior of the compact disk player and seat the disk on the turntable. The compact disk player further includes a drive means to rotate the turntable, and a clamping unit to prevent the disk from being undesirably removed from the turntable during rotation of the turntable. The compact disk player further includes an optical pickup unit which linearly reciprocates in a radial direction of the disk to record information on the disk or reproduce recorded information from the disk, and a conveying unit to reciprocate the optical pickup unit.

The conventional compact disk player having the above-mentioned construction can be used for different-sized disks, such as 80 mm disks and 120 mm disks. Typically, disk loading units of the compact disk players are designed to suit the 120 mm disks. Therefore, in the case that an 80 mm disk is inserted into the compact disk player, even after the 80 mm disk is seated on the turntable, the disk loading unit operates continuously.

To solve the above-mentioned problem, a disk identification method is required to identify the size of the disk inserted into the compact disk player and allow the disk to be loaded. To achieve the above-mentioned purpose, a method, which identifies the size of the disk using an optical signal, was proposed. A conventional compact disk player using this method is shown in FIGS. 1 and 2. The construction and operation of the conventional compact disk player will be described herein below with reference to FIGS. 1 and 2.

FIG. 1 shows the compact disk player into which a 120 mm disk D1 is inserted. The compact disk player includes a main body 10 which has an upper frame assembly 20 and a lower frame assembly 30. An inlet 40, into which a disk is inserted, is defined on the front of the main body 10. An optical device is provided on each of both sides of the upper and lower frame assemblies 20 and 30 which define the inlet 40 by being assembled together. In detail, two luminous elements 50 are provided around the inlet 40 on both sides of a lower surface of the upper frame assembly 20. Two light receiving elements 60 are provided on both sides of an upper surface of the lower frame assembly 30 to correspond to the luminous elements 50.

FIG. 1 illustrates the disk identification operation of the compact disk player when the 120 mm disk D1 is inserted into the compact disk player through the inlet 40. Referring to FIG. 1, when the 120 mm disk D1 is inserted into the compact disk player, light, emitted from the luminous elements 50 provided around the inlet 40, is blocked by the 120 mm disk D1. Then, the light receiving elements 60, provided on both sides of the upper frame assembly 20, cannot receive the lights. By this principle, the compact disk player senses that a 120 mm disk is inserted.

FIG. 2 illustrates the disk identification operation of the compact disk player when the 80 mm disk D2 is inserted into the compact disk player through the inlet 40. As shown in FIG. 2, in the case that the 80 mm disk D2 is inserted into the compact disk player trough the inlet 40, regardless of which portion of the inlet 40 the 80 mm disk D2 passes through, the 80 mm disk D2 intercepts one of lights emitted from the luminous elements 50, which are provided around the inlet 40 on both sides of the upper frame assembly 20. The light emitted from the other luminous element 50 reaches the associated light receiving element 60. At this time, the compact disk player senses that an 80 mm disk is inserted.

As such, the disk identification method using the light device is advantageous in that the process is simple. However, due to expensive luminous elements and light receiving elements, the manufacturing costs of the compact disk player are increased. Furthermore, in the case that the luminous elements and light receiving elements become displaced by outside impact, incorrect operation occurs. As well, the light devices are mounted to the compact disk player by soldering. As a result, there are problems of incorrect soldering and the occurrence of short-circuits due to the soldering.

To solve the above-mentioned problems, a new disk identification device capable of identifying the size of an inserted disk through a simple mechanical operation is necessary.

### SUMMARY OF THE INVENTION

Accordingly, the present invention has been made keeping in mind the above problems occurring in the prior art, and an object of the present invention is to provide a compact disk player for vehicles in which, when one of different-sized disks is inserted into the compact disk player, the size of the disk is mechanically identified and, thereafter, the disk is loaded into the interior of the compact disk player.

Another object of the present invention is to provide a compact disk player for vehicles which reduces the manufacturing costs by using a component, which is more economical than that of conventional compact disk players.

In order to accomplish the above object, the present invention provides a disk identification device provided around an inlet of a disk player, including: a first lever unit, having a first connection part, with a first disk guide provided on an end of the first connection part to guide a disk, a first drive part having a rack gear with uneven teeth and a second connection part to connect the first connection part to the drive part; a second lever unit, having a third connection part, with a second disk guide provided on an end of the third connection part to guide the disk, and a second drive part having a rack gear with uneven teeth; a pinion gear having a predetermined shape to engage with both the rack gear of the first lever unit and the rack gear of the second lever unit; and an elastic spring to couple the first lever unit to the second lever unit. The disk identification device identifies a size of the disk when the disk is inserted into the disk player through the inlet, thus allowing the disk to be loaded.

The rack gear provided in the first lever unit and the rack gear provided in the second lever unit to correspond to the rack gear of the first lever unit may include first and second brake parts, respectively, so that, when an 80 mm disk is inserted into the disk player, the first and second lever units are temporarily stopped at predetermined locations by the first and second brake parts.

### RIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a conventional compact disk player for vehicles showing a 120 mm disk inserted into the compact disk player;

FIG. 2 is an exploded perspective view of the compact disk player of FIG. 1 showing an 80 mm disk inserted into the compact disk player;

FIG. 3 is an exploded perspective view of a compact disk player for vehicles in which a disk identification device is mounted, according to an embodiment of the present invention;

FIG. 4 is a perspective view of the disk identification device of FIG. 3;

FIGS. 5a and 5b are plan views to show the operation of the disk identification device of FIG. 4 when an 80 mm disk is inserted into the compact disk player;

FIG. 6 is an enlarged view of a circled portion ‘B’ of FIG. 5b to show a balance of force between a pinion gear and a rack gear of a second lever unit of the disk identification device of FIGS. 5a and 5b during a braking operation of the disk identification device; and

FIGS. 7a through 7d are views to show the operation of the disk identification device of FIG. 4 when a 120 mm disk is inserted into the compact disk player.

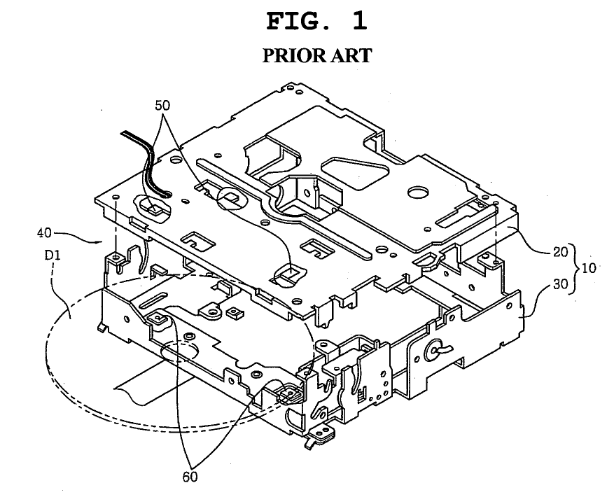

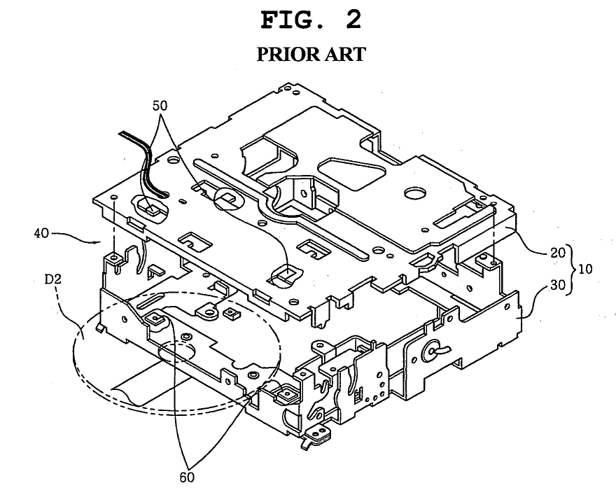

### DESCRIPTION OF THE PREFERRED EMBODIMENTS

Hereinafter, embodiments of the present invention will be described in detail with reference to the attached drawings.

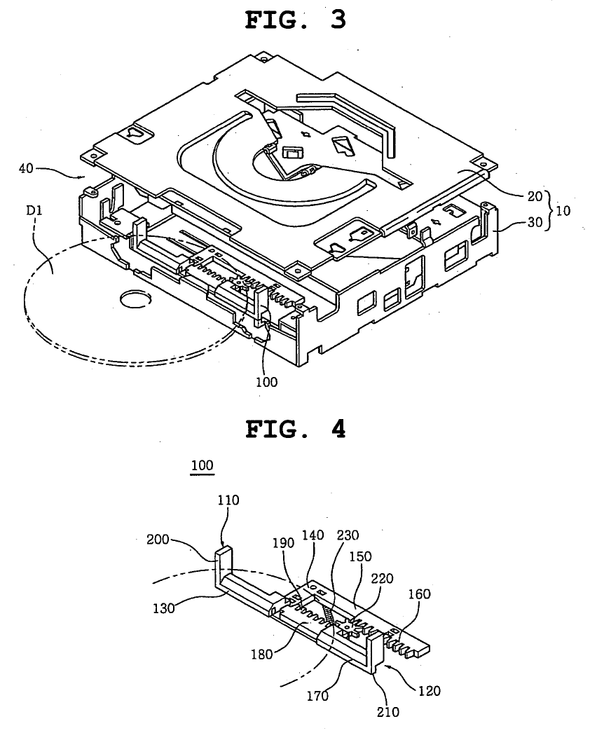

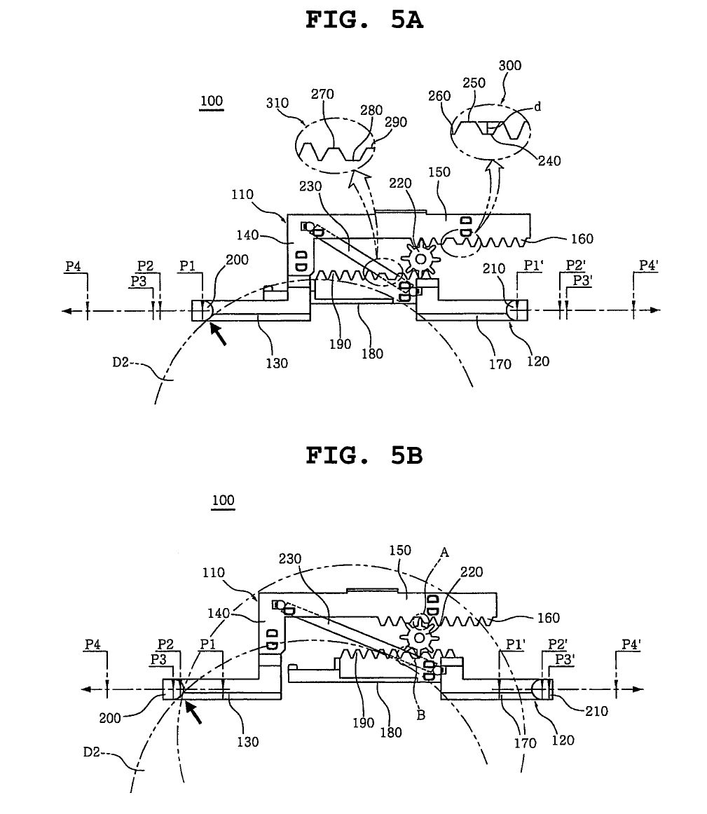

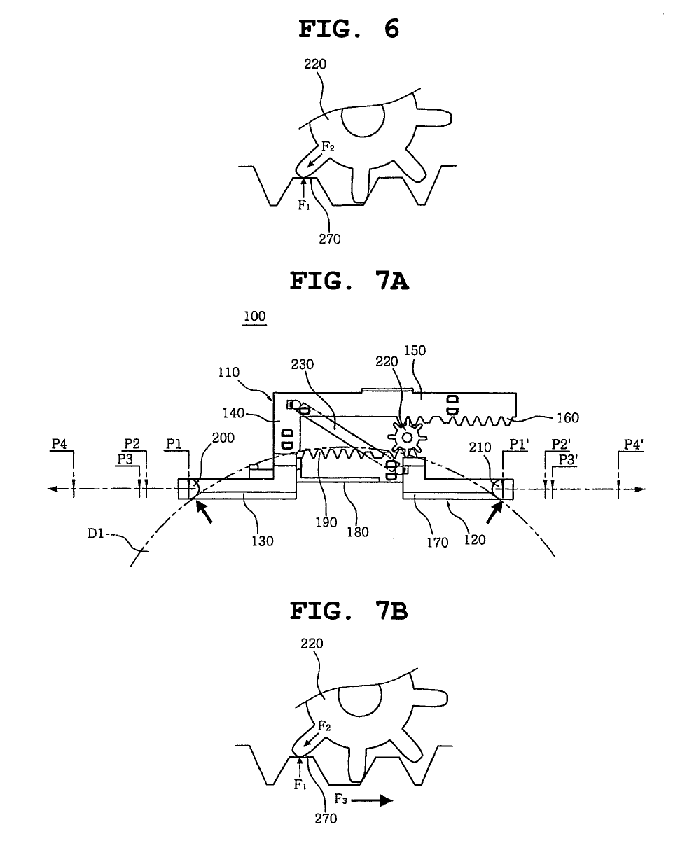

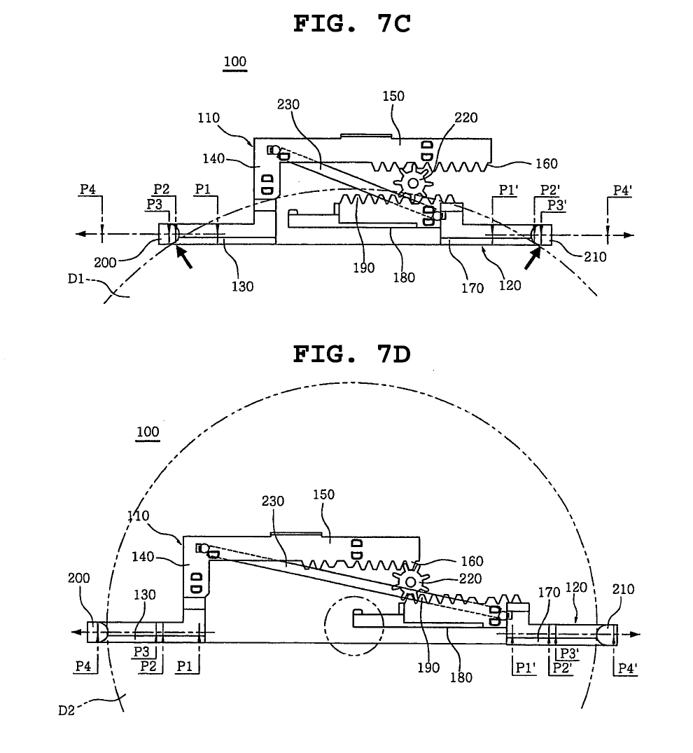

FIG. 3 is an exploded perspective view of a compact disk player for vehicles in which a disk identification device 100 is mounted, according to an embodiment of the present invention. FIG. 4 is a perspective view of the disk identification device 100 of FIG. 3. FIGS. 5a and 5b are plan views to show the operation of the disk identification device 100 of FIG. 4 when an 80 mm disk D2 is inserted into the compact disk player. FIG. 6 is an enlarged view of a circled portion ‘B’ of FIG. 5b. FIGS. 7a through 7d are views to show the operation of the disk identification device 100 of FIG. 4 when a 120 mm disk D1 is inserted into the compact disk player. The construction of the present invention will be described herein below in detail, based on the specific parts thereof. The components the same as those in conventional arts will be designated by the same reference numerals.

With reference to FIGS. 3 and 4, the disk identification device 100 of the compact disk player for vehicles according to the embodiment of the present invention will be described. As shown in FIG. 3, the compact disk player of the present invention includes a main body 10 which has an upper frame assembly 20 and a lower frame assembly 30. An inlet 40, into which a disk is inserted, is defined on the front of the main body 10. The disk identification device 100 is provided around the inlet 40 of the main body 10. The disk identification device 100 is coupled to the lower frame assembly 30 by a locking unit, such as a locking bolt, without soldering.

The disk identification device 100 to be coupled to the lower frame assembly 30 is shown in FIG. 4 in detail. With reference to FIG. 4, the construction of the disk identification device 100 is as follows. The disk identification device 100 includes a first lever unit 110, a second lever unit 120, a pinion gear 220 and an elastic spring 230. The first lever unit 110 has a first connection part 130, with a first disk guide 200 extending upwards a predetermined height from an end of the first connection part 130 to guide the disk. The first lever unit 110 further has a first drive part 150 which is provided with a first rack gear 160 having uneven teeth. The first lever unit 110 further has a second connection part 140 to connect the first connection part 130 to the first drive part 150. The second lever unit 120 corresponding to the first lever unit 110 has a third connection part 170, with a second disk guide 210 extending upwards a predetermined height from an end of the third connection part 170 to guide the disk. The second lever unit 120 further has a second drive part 180 which is provided with a second rack gear 190 having uneven teeth and connected to the third connection part 170.

The first and second lever units 110 and 120 are coupled to each other through the pinion gear 220 which engages with both the first and second rack gears 160 and 190 of the first and second lever units 110 and 120. Furthermore, the first and second lever units 110 and 120 are elastically coupled to each other by the elastic spring 230.

FIGS. 5a and 5b show the operation of the disk identification device 100 when the 80 mm disk D2 is inserted into the compact disk player. FIG. 5a shows the 80 mm disk D2 pushing the first lever unit 110 in the direction shown by the arrow when the 80 mm disk D2 is inserted into the disk identification device 100. FIG. 5b shows the 80 mm disk D2 passing through the disk identification device 100. As shown in FIGS. 5a and 5b, when the 80 mm disk D2 is inserted, the first and second lever units 110 and 120 linearly move in directions to pass through positions that are designated by the reference characters P1, P2, P3, P1′ and P2′. The pinion gear 220 rotates in a predetermined direction between the first and second lever units 110 and 120. At this time, the first and second lever units 110 and 120 are respectively biased in directions of the positions P1 and P1′ by the elastic spring 230 coupled between the first and second lever units 110 and 120.

The positions P1 and P1′ designate initial positions of the first and second disk guides 200 and 210 of the first and second lever units 110 and 120, respectively, before a disk is inserted into the compact disk player. The positions P2 and P2′ each designate a position at which, when the 80 mm disk D2 is inserted into the compact disk player while coming into contact with one disk guide of the two lever units, the other lever unit is stopped, thus guiding the 80 mm disk D2 to the center. The positions P3 and P3′ designate positions allowing the 80 mm disk D2 to pass through the disk identification device 100. The positions P4 and P4′ designate positions allowing the 120 mm disk D2 to pass through the disk identification device 100.

The process of passing the 80 mm disk D2 through the disk identification device 100 will be explained in detail with reference to FIGS. 5a and 5b. FIG. 5a shows the 80 mm disk D2 being inserted into the disk identification device 100 while pushing the first lever unit 110 in the direction shown by the arrow. When the 80 mm disk D2 is inserted into the disk identification device 100 while pushing the first disk guide 200 of the first lever unit 110, the first and second disk guides 200 and 210 move along with the first and second lever unit 110 and 120′ from the positions P1 and P1′ to the positions P2 and P2 as shown in FIG. 5b. That is, because the first and second lever units 110 and 120 are coupled to each other through the pinion gear 220, when the 80 mm disk D2 is inserted into the disk identification device 100, the first and second lever units 110 and 120 move simultaneously until the first and second disk guides 200 and 210 reach the positions P2 and P2′, which are separated from the positions P1 and P1′ by the same distance, respectively.

Continuously, due to the force of the 80 mm disk D2 pushing the first disk guide 200 of the first lever unit 110 in the direction shown by the arrow of FIG. 5b, the first disk guide 200 moves to the position P3 allowing the 80 mm disk D2 to pass through the disk identification device 100. However, at this time, the second disk guide 210 of the second lever unit 120 is maintained at the position P2′. In other words, while the 80 mm disk D2 is inserted into the disk identification device 100, movement of one of the first or second disk guide 200 or 210 of the first or second lever unit 110 or 120 is stopped at the position P2 or P2′. Such operation is achieved by first and second brake parts 300 and 310 which are respectively provided on the first and second rack gears 160 and 190 of the first and second lever units 110 and 120.

The structures of the first and second brake parts 300 and 310 are shown in FIG. 5a. The first brake part 300 is formed on the first rack gear 160 of the first lever unit 110. The second brake part 310 is formed on the second rack gear 190 of the second lever unit 120 to correspond to the first brake part 300. The shapes of the first and second brake parts 300 and 310 will be explained in detail, based on the first brake part 300. The first brake part 300 includes a first gear tooth 240, a second gear tooth 260 and a first space 250. The height (d) of each of the first and second gear teeth 240 and 260 is 50% to 100% of the height of remaining gear teeth of the first rack gear 160. The width of the first space 250 defined between the first and second gear teeth 240 and 260 is greater than the width of a space defined between the remaining gear teeth of the first rack gear 160. Here, the height (d) of each of the first and second gear teeth 240 and 260 is decided within a range capable of engaging the pinion gear 220 with both the first brake part 300 and the second brake part 310 as shown in FIGS. 5b and 6.

Hereinafter, the braking operation to stop the first and second lever units 110 and 120 at predetermined positions by the engagement of the pinion gear 220 and the first and second brake parts 300 and 310 will be described in detail. First, as shown in FIG. 5a, when the 80 mm disk D2 is inserted toward the first drive part 150 of the first lever unit 110, the first lever unit 110 moves to the left, that is, towards the position P2. Simultaneously, the pinion gear 220, which engages with the first rack gear 160 of the first lever unit 110, rotates counterclockwise. Then, the second lever unit 120, which engages with the pinion gear 220, moves to the right, that is, towards the position P2′. Continuously, the pinion gear 220 passes through both the second gear tooth 260 of the first brake part 300 and a fourth gear tooth 290 of the second brake part 310.

Thereafter, one tooth of the pinion gear 220, which has passed through the fourth gear tooth 290 of the second brake part 310, comes into contact with an upper surface of a third gear tooth 270 of the second brake part 310 as shown in the circled portion ‘B’ of FIG. 5b. As a result of this, the rotation of the pinion gear 220 is stopped. At this time, the second disk guide 210 of the second lever unit 120 is positioned at the position P2′. The first disk guide 200.of the first lever unit 110 is positioned at the position P2. Thereafter, as the 80 mm disk further enters the disk identification device 100 while pushing the first lever unit 110, the first lever unit 110 moves to the left until one tooth of the pinion gear 220 comes into contact with a sidewall of the first gear tooth 240 after passing over the first space 250 of the first brake part 300. At this position, the first lever unit 100 is stopped. The first disk guide 200 of the first lever unit 100 is positioned at the position P3. As a result, the movement of the first and second lever units 110 and 120 is stopped. As such, the braking operation of stopping the movement of the first and second lever units 110 and 120 is achieved by the above-mentioned interaction among the pinion gear 220 and the first and second brake parts 300 and 310.

Furthermore, when the first disk guide 200 of the first lever unit 110 is positioned at the position P3 and the second disk guide 210 of the second lever unit 120 is positioned at the position P2′, a distance between the first and second disk guides 200 and 210 allows the 80 mm disk to pass through the disk identification device 100.

As such, the above-mentioned operation of the pinion gear 220 and the first and second brake parts 300 and 310 allows the 80 mm disk D2, inserted through the inlet 40 of the compact disk player, to be loaded into the compact disk player.

In other words, when the 80 mm disk D2 is inserted into the compact disk player, the second lever unit 120 is stopped at the position P2′ and the first lever unit 110 is stopped at the position P3. At this time, forces among the pinion gear 220 and the first and second lever units 110 and 120 are balanced as shown in the circled portions ‘A’ and ‘B’ of the FIG. 5b. FIG. 6 shows enlargement of the circled portion ‘B’ of FIG. 5b to explain such balance of force in detail. With reference to FIG. 6, the detailed explanation of the balance of force is as follows. An end of each tooth of the pinion gear 220 is angled in a polygonal shape. Therefore, when one tooth of the pinion gear 220 comes into contact with the third gear tooth 270 of the second brake part 310, a surface formed between an upper surface and a sidewall of the tooth of the pinion gear 220 comes into contact with the upper surface of the third gear tooth 270.

At this time, as shown in FIG. 6, a force F₂ of the pinion gear 220 balances with a force F₁ of the third gear tooth 270 corresponding to the force F₂. Thus, the movement of the pinion gear 220 and the first and second lever units 110 and 120 are stopped. In this state, even though the force of the 80 mm disk D2 pushing the first disk guide 200 of the fist lever unit 110 in the direction shown by the arrow is increased, the first and second lever units 110 and 120 do not move any longer. Thereafter, the 80 mm disk D2, inserted through the inlet 40, is guided by the first and second disk guides 200 and 210 and loaded onto a turntable into the compact disk player. In the meantime, even when the 80 mm disk D2 is inserted into the compact disk player while pushing the second disk guide 210 of the second lever unit 120, the disk identification device 100 is operated in the same manner as that described for the above-mentioned embodiment. However, in this case, the second lever unit 120 is moved to a position P3′, and the first lever unit 110 is moved to the position P2. At these positions, the 80 mm disk D2, inserted through the inlet 40, is loaded into the compact disk player.

Hereinafter, operation of the disk identification device 100 will be described when the 120 mm disk D1 is inserted into the compact disk player through the inlet 40. FIGS. 7a through 7d show the operation of the disk identification device 100 from the insertion of the 120 mm disk D1 through the inlet 40 to its loading process. Referring to FIG. 7a, when the 120 mm disk D1 is inserted into the compact disk player through the inlet 40, the 120 mm disk D1 simultaneously pushes the first and second disk guides 200 and 210 of the first and second lever units 110 and 120 in directions from the positions P1 and P1′ to positions P4 and P4′, respectively. At this time, because both the first lever unit 100 and the second lever unit 120 engage with the pinion gear 220 and are symmetrical around the pinion gear 220, the first and second lever units 110 and 120 move in opposite directions the same distance.

As the 120 mm disk D1 moves toward the interior of the compact disk player, the first and second lever units 110 and 120 move until the first and second disk guides 200 and 210 respectively reach the positions P3 and P3′ after passing through the predetermined positions, at which, when the 80 mm disk D2 is inserted, the movement of the first and second lever units 110 and 120 are stopped as shown in FIG. 5b. That is, this means that the balance of force created in the state of FIG. 5b is broken. This process is shown in FIG. 7b. As shown in FIG. 7b, in the state in which one tooth of the pinion gear 220 is in contact with the third gear tooth 270, that is, the force F₂ of the pinion gear 220 balances with the force F₁ of the third gear tooth 270, when the 120 mm disk D1 pushes the second lever unit 120 to the right, a force F₃ is applied to the second lever unit 120. Therefore, the balance of force, created among the pinion gear 220 and the first and second lever units 110 and 120, is broken. Thus, as shown in FIG. 7c, the first and second lever units 110 and 120 continuously move toward the positions P3 and P3′, respectively.

Such operation is achieved by the 120 mm disk D1 simultaneously pushing both the first and second lever units 110 and 120. As such, in the present invention, a disk can be loaded into the compact disk player regardless of the size of the disk. Continuously, as the 120 mm disk D1 further enters the disk identification device 100, the first and second lever units 110 and 120, which have moved to the positions P3 and P3′, move until the first and second disk guides 200 and 210 reach the positions P4 and P4′, respectively, as shown in FIG. 7d. Here, the distance between the positions P4 and P4′ allows the 120 mm disk D1 to pass through the disk identification device 100. At this time, the disk player allows the 120 mm disk D1, inserted through the inlet 40, to be loaded into the compact disk player.

As described above, the present invention is characterized in that the first and second lever units 110 and 120, made of resin, the pinion gear 220 and the elastic spring 230 constitute the disk identification device 100 and, as well, the disk identification device 100 is coupled to the lower frame assembly 30 by the simple locking unit, such as a locking bolt. In other words, in conventional compact disk players, a plurality of expensive components, such as optical devices, is mounted to a compact disk player by soldering to serve as a disk identification device. Therefore, the conventional compact disk players are problematic in that manufacturing costs are high. Furthermore, in the case that the optical device becomes dislodged due to faulty soldering or outside impact, incorrect operation occurs. However, because the disk identification device 100 of the present invention is mechanically operated, the above-mentioned problems are overcome. That is, the disk identification device 100 is advantageous in that manufacturing costs are reduced and it is not easily put out of order. In addition, the disk identification device 100 is easily assembled with the lower frame assembly 30 of the compact disk player.

In other words, typically, the compact disk players include a turntable to seat a disk thereon, and a disk loading unit to load the disk into the interior of the compact disk player and seat the disk on the turntable. The compact disk player further includes a drive means to rotate the turntable, and a clamping unit to prevent the disk from being undesirably removed from the turntable during rotation of the turntable. The compact disk player further includes an optical pickup unit which linearly reciprocates in a radial direction of the disk to record information on the disk or to reproduce recorded information from the disk, and a conveying unit to reciprocate the optical pickup unit. In the compact disk player having the above-mentioned construction, the disk identification device 100 to identify the size of the disk is provided around the inlet of such compact disk player through a simple assembly process. Thus, the compact disk player, which mechanically allows the disk to be loaded regardless of the size of the disk, is provided.

In a brief description of the operation of the disk identification device 100, the disk identification device 100 of the present invention identifies the size of the disk using the mechanical operation and allows the disk to be loaded. When the 80 mm disk D2 is inserted into the compact disk player through the inlet 40, because the 80 mm disk D2 is relatively small in size, one disk guide 200 or 210 of the first and second lever units 110 or 120 is pushed by the 80 mm disk D2. Then, until the disk guide 200 or 210, which contacts the 80 mm disk D2, is positioned at the position P3 or P3′, the associated lever unit 110 or 120 moves. The other lever unit 110 or 120 moves until the associated disk guide 200 or 210 is positioned at the position P2 or P2′. At these positions, the movement of the first and second lever units 110 and 120 are stopped. The 80 mm disk D2 is loaded into the interior of the compact disk player.

When the 120 mm disk D1 is inserted into the compact disk player, the 120 mm disk D1 pushes both first and second disk guides 200 and 210 of the first and second lever units 110 and 120 outwards. Because the 120 mm disk D1 simultaneously applies the force to both the first and second lever units 110 and 120, the first and second lever units 110 and 120 move until the first and second disk guides 200 and 210 reach the positions P4 and P4′ without braking action, unlike the insertion of the 80 mm disk D2. At these positions, the movement of the first and second lever units 110 and 120 are stopped. The 120 mm disk D1, inserted through the inlet 40, is loaded into the interior of the compact disk player.

As described above, the present invention provides a compact disk player which identifies the size of a disk using a disk identification device having a simple mechanical structure and loads the disk into the compact disk player. Therefore, the compact disk player of the present invention solves problems of an increase of costs and incorrect operation experienced with conventional compact disk players using optical devices to identify the size of the disk.

Furthermore, because the compact disk player identifies the size of the disk by the mechanical method, the compact disk player has a simple construction, thus being convenient in a process of assembling the compact disk player. In addition, components constituting the disk identification device are made of resin, thus reducing manufacturing costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A disk identification device provided around an inlet of a disk player, comprising:
a first lever unit, comprising:
a first connection part, with a first disk guide provided on an end of the first connection part to guide a disk;
a first drive part having a rack gear with uneven teeth; and
a second connection part to connect the first connection part to the drive part;
a second lever unit, comprising:
a third connection part, with a second disk guide provided on an end of the third connection part to guide the disk; and
a second drive part having a rack gear with uneven teeth;
a pinion gear having a predetermined shape to engage with both the rack gear of the first lever unit and the rack gear of the second lever unit; and
an elastic spring to couple the first lever unit to the second lever unit,
wherein the disk identification device identifies a size of the disk when the disk is inserted into the disk player through the inlet, thus allowing the disk to be loaded.

2. The disk identification device as set forth in claim 1, wherein the rack gear provided in the first lever unit and the rack gear provided in the second lever unit to correspond to the rack gear of the first lever unit comprise first and second brake parts, respectively, so that, when an 80 mm disk is inserted into the disk player, the first and second lever units are temporarily stopped at predetermined locations by the first and second brake parts.

3. The disk identification device as set forth in claim 2, wherein each of the first and second brake parts of the first and second lever units comprises a first gear tooth, a second gear tooth and a space defined between the first and second gear teeth, wherein a height of each of the first and second gear teeth is 50% to 100% of a height of remaining gear teeth of each of the rack gears, and a width of the space between the first and second gear teeth is greater than a width of a space defined between the remaining gear teeth of each of the rack gears.

4. The disk identification device as set forth in claim 2, wherein the first and second brake parts are respectively formed at predetermined positions on the first and second lever units to stop movement of the first and second lever units at the predetermined locations when the 80 mm disk is inserted into the disk player.

5. The disk identification device as set forth in claim 3, wherein the first and second brake parts are respectively formed at predetermined positions on the first and second lever units to stop movement of the first and second lever units at the predetermined locations when the 80 mm disk is inserted into the disk player.

6. A compact disk player for vehicles to record information onto a disk and to reproduce the recorded information from the disk, comprising:
a disk identification device to identify a size of the disk when the disk is inserted into an inlet of the compact disk player;
a turntable to seat the disk thereon;
a disk loading unit to load the disk, identified in size by the disk identification device, into the compact disk player and to seat the disk onto the turntable;
a drive unit to rotate the turntable;
a clamping unit to prevent the disk from being removed from the turntable during a rotation of the turntable;
an optical pickup unit to be reciprocated in a radial direction above the disk to record information onto the disk or to reproduce recorded information from the disk; and
a conveying unit to reciprocate the optical pickup unit over the disk.

7. The compact disk player as set forth in claim 6, wherein the disk identification device comprises:
a first lever unit, comprising:
a first connection part, with a first disk guide provided on an end of the first connection part to guide a disk;
a first drive part having a rack gear with uneven teeth; and
a second connection part to connect the first connection part to the drive part;
a second lever unit, comprising:
a third connection part, with a second disk guide provided on an end of the third connection part to guide the disk; and
a second drive part having a rack gear with uneven teeth;
a pinion gear having a predetermined shape to engage with both the rack gear of the first lever unit and the rack gear of the second lever unit; and
an elastic spring to couple the first lever unit to the second lever unit.

8. The compact disk player as set forth in claim 6, wherein the rack gear provided in the first lever unit and the rack gear provided in the second lever unit to correspond to the rack gear of the first lever unit comprise first and second brake parts, respectively, so that, when an 80 mm disk is inserted into the disk player, the first and second lever units are temporarily stopped at predetermined locations by the first and second brake parts.

9. The disk identification device as set forth in claim 8, wherein each of the first and second brake parts of the first and second lever units comprises a first gear tooth, a second gear tooth and a space defined between the first and second gear teeth, wherein a height of each of the first and second gear teeth is 50% to 100% of a height of remaining gear teeth of each of the rack gears, and a width of the space between the first and second gear teeth is greater than a width of a space defined between remaining gear teeth of each of the rack gears.

10. The disk identification device as set forth in claim 8, wherein the first and second brake parts are respectively formed at predetermined positions on the first and second lever units to stop movement of the first and second lever units at the predetermined locations when the 80 mm disk is inserted into the disk player.

11. The disk identification device as set forth in claim 9, wherein the first and second brake parts are respectively formed at predetermined positions on the first and second lever units to stop movement of the first and second lever units at the predetermined locations when the 80 mm disk is inserted into the disk player.
